(19) United States
(12) Patent Application Publication
(10) Pub. No.: US 2021/0162887 A1
(43) Pub. Date: Jun. 3, 2021

(54) SEAT ACCESSORY DEVICE

(71) Applicant: Donald Taylor, Cullman, AL (US)

(72) Inventor: Donald Taylor, Cullman, AL (US)

(21) Appl. No.: 16/699,737

(22) Filed: Dec. 2, 2019

(51) Int. Cl. B60N 2/005; B60N 2/70

(52) U.S. Cl. CPC B60N 2/005; B62D 33/0273; B60N 2/70

(57) ABSTRACT

A seat accessory device having a body including a seat member and an attachment member. The seat member includes a cushion element. The attachment member includes a pair of strap elements attached to each end of the seat member, and a pair of hook elements attached to each pair of strap elements. Each pair of hook elements is positioned at an opposite end of the seat member from one another. Each pair of hook elements includes mating components to connect to one another. The seat member attachably connects to an object by extending the opposite positioned strap elements around the object and connecting the opposite positioned hook elements to one another.

### FIELD OF THE INVENTION

Embodiments described herein generally relate to accessory devices, and more particularly to a seat accessory device.

### BACKGROUND OF THE INVENTION

Tailgate party events commonly occur in the parking lots at stadiums and arenas, before and occasionally after games and concerts. Typically, the party is held on and around the open tailgate of a vehicle. The tailgate of the vehicle is sometimes used as seating for one or more individuals which can be uncomfortable to the users because the tailgate is usually made of very hard material, such as, plastic or steel. Traditional tailgate seat accessories are difficult to use because placing them correctly on the back of a flatbed is tedious because of the weight of the accessories and the need for tools to get them installed. Hence a comfortable and easy to use seat accessory is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a tailgate seat device according to an embodiment of the present disclosure.

### SUMMARY OF THE INVENTION

Exemplary embodiments disclosed herein describe a seat accessory device having a body including a seat member and an attachment member. The seat member includes a cushion element. The attachment member includes a pair of strap elements attached to each end of the seat member, and a pair of hook elements attached to each pair of strap elements. Each pair of hook elements is positioned at an opposite end of the seat member from one another. Each pair of hook elements includes mating components to connect to one another. The seat member attachably connects to an object by extending the opposite positioned strap elements around the object and connecting the opposite positioned hook elements to one another.

In some exemplary embodiments, the connection of the seat member to the object is semi-permanent.

In some exemplary embodiments, the opposite positioned strap elements are extended around the object in a direction away from one another.

In some exemplary embodiments, the strap elements are elastic straps.

In some exemplary embodiments, the hook elements are plastic seat fasteners.

In some exemplary embodiments, the hook element is attached to a distal end of a corresponding strap element.

In some exemplary embodiments, each strap element attaches to the seat member at a proximate end of the strap element.

In some exemplary embodiments, the upholstered cushion element includes foam padding.

In some exemplary embodiments, the cushion element is upholstered with fabric.

In some exemplary embodiments, the fabric is personalized.

In some exemplary embodiments, the fabric is personalized with at least one or more from the group comprising color, logo and print.

In some exemplary embodiments, the object is a tailgate.

### DETAILED DESCRIPTION

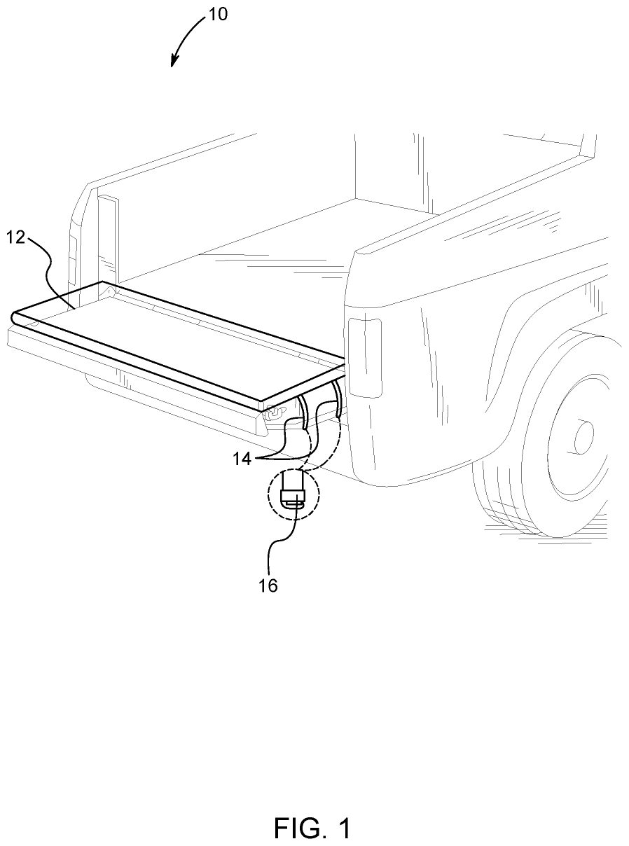

The present disclosure relates to a seat accessory device (“the device”). The device 10 provides a comfortable, light weight and easy to use seating accessory. As illustrated in FIG. 1, the device 10 includes a body member including seat member 12 and attachment member 14 and 16. The seat member 12 includes a cushion element. The attachment member 14 includes a pair of strap elements 14 and a pair of hook members 16. The cushion element in the seat member 12 may include foam padding and may be upholstered with fabric. The fabric may be personalized with a special color, logo or print. The strap elements 14 may be elastic straps. The hook elements 16 may be plastic seat fasteners.

The attachment member 14 and 16 attaches to seat member 12. Specifically, the pair of strap elements 14 are attached to each end of the seat member 12. The pair of hook elements 16 are positioned at an opposite end of the seat member 12 from one another. Each pair of hook elements 16 includes mating components to connect to one another. The proximate ends of strap elements 14 are connected directly to seat member 12. The distal ends of strap elements 14 are attached to hook elements 16.

The attachment member 14 and 16 connects the seat member 12 to an object. Any suitable object may be attached to the seat member. In a preferred embodiment, the seat member 12 is attached to a tailgate. The hook elements 16 provide a semi-permanent connection of the seat member 12 to the object. The seat member 12 attachably connects to the object by extending the opposite positioned strap elements 14 around the object and connecting the opposite positioned hook elements 16 to one another. The opposite positioned strap elements 14 are extended around the object in a direction away from one another.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A seat accessory device comprising:
a body having a backless seat member including an upholstered cushion element and an attachment member including a pair of strap elements attached to each end of the seat member, and a pair of hook elements attached to each pair of strap elements, each pair of hook elements is positioned at an opposite end of the seat member from one another and each pair of hook elements includes mating components to connect to one another, wherein the seat member attachably connects to an object by extending the opposite positioned strap elements around the object and connecting the opposite positioned hook elements to one another, wherein the backless seat member is configured to be positioned on an interior surface of the object and the pair of strap and hook elements are configured to connect to one another on an external surface of the object.

2. The device of claim 1, wherein the connection of the seat member to the object is semi-permanent.

3. (canceled)

4. The device of claim 1, wherein the strap elements are elastic straps.

5. The device of claim 1, wherein the hook elements are plastic seat fasteners.

6. The device of claim 1, wherein each hook element is attached to a distal end of a corresponding strap element.

7. The device of claim 1, wherein each strap element attaches to the seat member at a proximate end of the strap element.

8. The device of claim 1, wherein the upholstered cushion element includes foam padding.

9. The device of claim 1, wherein the cushion element is upholstered with fabric.

10. The device of claim 9, wherein the fabric is personalized.

11. The device of claim 10, wherein the fabric is personalized with at least one or more from the group comprising color, logo and print.

12. The device of claim 1, wherein the object is a tailgate.
